(19) United States
(12) Patent Application Publication
(10) Pub. No.: US 2010/0100950 A1
(43) Pub. Date: Apr. 22, 2010

(54) CONTEXT-BASED ADAPTIVE AUTHENTICATION FOR DATA AND SERVICES ACCESS IN A NETWORK

(76) Inventor: JAY B. ROBERTS, Silver Spring, MD (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/467,561

(22) Filed: May 18, 2009

Related U.S. Application Data
(60) Provisional application No. 61/106,657, filed on Oct. 20, 2008.

(51) Int. Cl. H04L 9/32; G06F 15/16; G06F 21/00

(52) U.S. Cl. 726/7; 709/229

(57) ABSTRACT

A method includes sending a command set to a client module via a network, receiving via the network a context identifier and a data set associated with the command set, verifying the command set, and authenticating the client module. The command set is verified based on the data set. The client module is authenticated based on the context identifier. A service is made accessible to the client module after the authenticating, The service is inaccessible to the client module before the authenticating.

### CROSS-REFERENCE TO RELATED APPLICATION

This application claims priority to U.S. Provisional Patent Application Ser. No. 61/106,657, filed on Oct. 20, 2008, and entitled “Context-Based Adaptive Authentication for Data and Services Access in a Network ,” which is incorporated herein by reference in its entirety.

### BACKGROUND

Embodiments disclosed herein relate generally to authenticated access to resources over a network including, for example, authenticated access based on a verified command set and context. Additionally, some embodiments disclosed herein can provide authentication of a client based on a context of the client and a command set related to the context.

Known methods of authentication between a client and a server are generally limited to authentication based on attributes or properties of client. For example, methods of authentication based on a token or key held by a client, or an external internet protocol (“IP”) address are known. Additionally, password-based authentication is also known.

Such authentication methods, however, fail to provide for authentication of clients with a server based on the context in which the client is attempting to access the server. Thus, a need exists for improved client authentication.

### SUMMARY OF THE INVENTION

A method includes sending a command set to a client module via a network, receiving via the network a context identifier and a data set associated with the command set, verifying the command set, and authenticating the client module. The command set is verified based on the data set. The client module is authenticated based on the context identifier. A service is made accessible to the client module after the authenticating, The service is inaccessible to the client module before the authenticating.

### BRIEF DESCRIPTION OF THE DRAWINGS

FIG. 1 is a system block diagram of a system for providing access to content based on a context, according to an embodiment.

FIG. 2 is a system block diagram of another system for providing access to content based on a context, according to another embodiment.

FIG. 3 is a flowchart of a process for providing access to content based on a context, according to an embodiment.

FIG. 4 is a signal flow in a system for authenticating a client module with a server module based on a context, according to an embodiment.

FIG. 5 is a signal flow communication in another system for authenticating a client module with a server module based on a context, according to another embodiment.

### DETAILED DESCRIPTION

One or more embodiments disclosed herein are capable of authorizing a client module to communicate with one or more server modules and/or to authorize service requests from a client module to a server module based on the context of the communication or request. In other words, embodiments disclosed herein are capable of establishing a trusted client-side environment at a server for executing client-side code. In one embodiment, a person using an Internet or web browser (also referred to as a browser) to view a webpage such as, for example, a user profile (owned or managed by another person) on a website can access an identity validation (or identity credential) of the owner of the user profile. In other words, a person viewing the user profile of another person can receive an indication that the other person is not misrepresenting his or her identity in his or her user profile.

More specifically, for example, a validation service-provider can, for example, define an identity credential for a subscriber to the validation service-provider (“the validation-service subscriber”) after validating his or her identity. The identity can be validated based on, for example, background checks, criminal history checks, employment checks or verification, and/or personal interviews. The identity credential or validation can be a compilation of data such as, for example, age, sex, employment status, criminal history, education history, and/or other data related to the identity of the validation-service subscriber. In some embodiments, an identity credential can include one or more images of the validation-service subscriber.

The validation service-provider can provide access to the identity credential in a context such as, for example, a user profile associated with the validation-service subscriber on a social networking website. In some embodiments, the validation service-provider can provide access to data and/or services other than an identity validation. In other words, the validation service-provider can provide access to the validation-service subscriber's identity credential (or other data) to a validation-service accessing party. For example, a validation-service accessing party can be a user of a web browser viewing the validation-service subscriber's user profile on a social networking site. The validation service-provider can provide access to the validation-service subscriber's identity credential to the validation-service accessing party when the validation-service accessing party is viewing the validation-service subscriber's user profile, but deny access to the validation-service subscriber's identity credential when the validation-service accessing party attempts to access the identity credential from another context such as, for example, a webpage not associated with the validation-service subscriber.

In some embodiments, a client module such as, for example, a browser plug-in can be configured to interact with a browser running on a computer and a server module that has access to the identity credential to authorize access to the identity credential. For example, the validation-service accessing party can view with a web browser the validation-service subscriber's user profile that includes an indication (e.g., an icon or image) of the availability of an identity credential associated with the validation-service subscriber. The validation-service accessing party can click on that indication and the browser can retrieve a software module such as, for example, a script or executable file. The software module can be retrieved from a server where the user profile is stored, the validation service-provider, or some other source. After retrieving the software module, the browser can provide the software module to the browser plug-in to be executed or interpreted to access the validation-service subscriber's identity credential.

Additionally, the browser provides the context of the software module, or a portion thereof, to the browser plug-in. In other words, the browser can provide to the browser plug-in information related to the circumstances, setting, or background from which the software module was retrieved or accessed. For example, a website, a specific webpage, and a portion of a webpage can each be a context; a computer server identified by, for example, an IP address or domain name can be a context; and a local area network (“LAN”) such as an intranet can be a context. The context can be provided to the browser plug-in as a context identifier such as, for example, a uniform resource identifier (“URI”) such as a uniform resource locator (“URL”). Said differently, the browser can provide to the browser plug-in the software module and context-identifying information such as the Internet or web address of the validation-service subscriber's user profile. In some embodiments, the context identifier can identify a portion of a context or one or more characteristics of a context (or, context characteristics). For example, an entire URL can completely identify a context, but in some instances a client module can be authenticated for access to data based on a context characteristic such as, for example, a single webpage identifier, a network identifier, or IP address. In some embodiments, a web host or domain name can be a context characteristic.

The browser plug-in can use the software module and context or context characteristic to access data such as, for example, the identity credential. For example, the software module can include commands or instructions (or a command set or an instruction set) configured to cause the browser plug-in to request the identity credential and/or other data from a server module associated with the validation service-provider. In some embodiments, the browser plug-in calculates a checksum or hash value based on the software module and provides the checksum, URL (or other context), and a request for the validation-service subscriber's identity credential to the server module in response to commands in the software module. The checksum can be a value determined based on the contents of the software module using a checksum algorithm to ensure with a high probability that any changes to the software module result in changes to the checksum (or value). The server module receives the checksum, URL, and request, and determines whether to provide the validation-service subscriber's identity credential to the browser plug-in.

The server module first verifies that the software module has not been changed or altered based on the checksum. In other words, the server module determines whether the software module has been altered based on a comparison of the checksum received from the browser plug-in and a checksum accessible to the server module. For example, the server module can have access to a database of checksums associated with software modules. If the checksum provided by the browser plug-in is the same as a checksum in the database associated with the software module received by the browser, the server module verifies that the software module has not been altered.

After the software module is verified, the server module can validate the request for the validation-service subscriber's identity credential and/or the browser plug-in based on the URL (or context) provided by the browser plug-in. In some embodiments, the URL can be compared with a list of URLs approved by the validation-service subscriber to provide access to the validation-service subscriber's identity credential. If the URL (or some portion thereof) is included in the list, the validation-service subscriber's identity credential can be provided to the browser plug-in and displayed in the browser to the validation-service accessing party. In other embodiments, an authentication module can use a portion of the URL to access an application programming interface (“API”) to determine whether the browser plug-in is authorized to access the validation-service subscriber's identity credential. For example, the URL can include an identifier associated with the name of the validation-service subscriber by a social networking website. The authentication module can provide the identifier to the social networking site via an API provided by the social networking site and the social networking site can provide a name via the API to the server module based on the identifier. If the name provided to the server module is the same as a name associated with the validation-service subscriber, the authentication module can provide the validation-service subscriber's identity credential to the browser plug-in for display in the browser.

In some embodiments, the authentication module of the server module can request additional data from the browser plug-in and/or the validation-service accessing party attempting to access the identify credential via the browser plug-in and browser, if the authentication module cannot determine whether the browser plug-in is authorized to access the validation-service subscriber's identity credential based on the context (or one or more context characteristics) already provided by the browser plug-in. For example, an API can require a username and password (e.g., of any person registered with the social networking website) to access data associated with a user profile via the API. The server module can send commands to the browser plug-in to request a username and password from the validation-service accessing party via, for example, the browser. The browser plug-in can then provide the password to the server module, and the authentication module can use the username and password to authenticate access to the identity credential. As another example, a server module can request additional context characteristics from the browser plug-in if the browser plug-in did not provide a complete context to the server module and additional context characteristics are available to the browser plug-in.

As used in this specification, the singular forms “a,” “an,” and “the” include plural referents unless the context clearly dictates otherwise. Thus, for example, the term “a computer server” is intended to mean a single computer server or a combination of computer servers, “a processor” is intended to mean one or more processors, or a combination thereof.

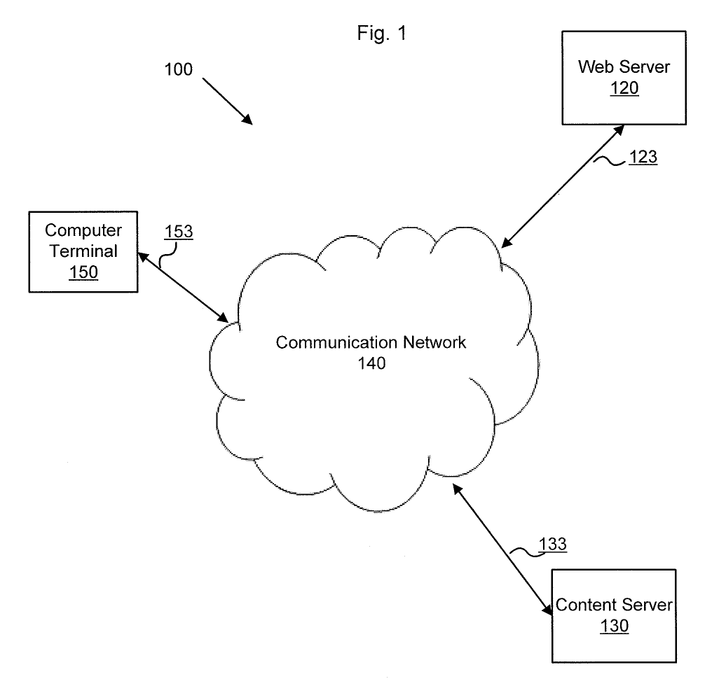

FIG. 1 is a system block diagram of system 100 for providing access to network content based on a context, according to an embodiment. System 100 includes web server 120, content server 130, and computer terminal 150 operatively coupled to communication network 140. Computer terminal 150 can be any of a variety of communication devices that can be operatively coupled to communication network 140. For example, a computer terminal can be a personal computer, a laptop computer, a personal digital assistant (“PDA”), a cellular telephone, and/or some other communication device. Computer terminal 150 can include a web browser configured to access a webpage or website hosted on or accessible via web server 120 over communication network 140. A webpage or website can be accessed by a user of a web browser at computer terminal 150 by providing the web browser with a reference such as a URL, for example, of a webpage. In some embodiments, computer terminal 150 can include specialized software for accessing web server 120 other than a browser such as, for example, a specialized network-enabled application or program.

In some embodiments, portions of a website accessible via web server 120 can be located in a database (not shown) accessible to web server 120. Web server 120 can provide access to a webpage including a reference or link to a command set or file. Such a command set or file can include instructions or code for retrieving content such as, for example, validated information related to the webpage and located on content server 130. In some embodiments, the command set can be located on web server 120, or in a database or on a computer server (not shown) accessible to web server 120. In other words, the command set can be provided to computer terminal 150 from web server 120. In other embodiments, the command set can be located on or be accessible to a network resource such as, for example, content server 130 or another computer server (not shown) operatively coupled to communication network 140, and provided to computer terminal 150 from that network resource. For example, a webpage hosted by web server 120 can include a link (or reference) to a file located on content server 130. A user of computer terminal 150 viewing the webpage with a web browser can click on the link and the web browser can download the file from content server 130.

The command set can provide commands or instructions to computer terminal 150 or, for example, to a web browser and/or web browser plug-in executing (or running) on computer terminal 150. Computer terminal 150 can interpret the commands to interact with content server 130 over communication network 140 to access content or data located or stored on content server 130. For example, based on the command set, computer terminal 150 can request data from content server 130. In some embodiments, a request can include a portion of the command set and/or a data value such as a hash value based on the command set, and the URL of the webpage including the link to the command set for verification and/or authorization to access an image file, a video file, and/or protected content. Content server 130 can, for example, verify that the hash value based on the command set is unchanged from a previously calculated hash value based on the command set. Additionally, content server 130 can verify that the URL including the link is approved or authorized to include the link to the command set before authorizing access for computer terminal 150 to content or data requested by computer terminal 150.

After the verification and/or authorization, content server 130 can provide (e.g., send, transmit, or make available for download) the requested data or content. In some embodiments, computer terminal 150 can provide commands such as, for example, image processing commands, video processing commands, data retrieval commands, and/or other processing commands to content server 130 that can be executed by content server 130 after content server 130 determines that computer terminal 150 is authorized to request execution of the commands. In other words, content server 130 can provide or make available (or accessible) after the verification and/or authorization a service to computer terminal 150 that was not available (or accessible) to computer terminal 150 before the verification and/or authorization. Said differently, after computer terminal 150 is authorized for access to a service provided by content server 130, content server 130 can execute or perform actions (e.g., retrieve and send data, or perform some processing) requested by computer terminal 150.

Communication network 140 can be any communication network configurable to allow web server 120, content server 130 and computer terminal 150 to communicate with communication network 140 and/or to each other through communication network 140. In other words, communication network 140 can be any network or combination of networks capable of transmitting information (e.g., data and/or signals) including, for example, a telephone network, an Ethernet network, a fiber-optic network, a wireless network, and/or a cellular network.

In some embodiments, communication network 140 can include multiple networks operatively coupled one to another by, for example, network bridges, routers, switches and/or gateways. For example, computer terminal 150 can be operatively coupled to a cellular network, web server 120 can be operatively coupled to an Ethernet network, and content server 130 can be operatively coupled to a fiber-optic network. The cellular network, Ethernet network and fiber-optic network can each be operatively coupled one to another via one or more network bridges, routers, switches and/or gateways such that the cellular network, the Ethernet network and the fiber-optic network are operatively coupled to form collectively a communication network. Alternatively, for example, the cellular network, the Ethernet network and the fiber-optic network can each be operatively coupled to the Internet such that the cellular network, the Ethernet network, the fiber-optic network and the Internet are operatively coupled to form collectively a communication network.

As illustrated in FIG. 1, web server 120 is operatively coupled to communication network 140 via network connection 123; content server 130 is operatively coupled to communication network 140 via network connection 133; and computer terminal 150 is operatively coupled to communication network 140 via network connection 153. Network connections 123, 133 and 153 can be any appropriate network connection for operatively coupling web server 120, content server 130 and computer terminal 150, respectively, to communication network 140.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection. In some embodiments, a computer terminal, a web server and/or a content server can be operatively coupled to a communication network by heterogeneous network connections. For example, a computer terminal can be operatively coupled to the communication network by a WWAN network connection, a web server can be operatively coupled to the communication network by a DSL network connection, and a content server can be operatively coupled to the communication network by a fiber-optic network connection.

In some embodiments web server 120, content server 130, and/or computer terminal 150 includes (not shown) a processor, a network interface, and a memory. For example, web server 130 can be operatively coupled to communication network 140 via a network interface and network connection 133. The network interface can be any network interface configurable to be operatively coupled to communication network 140 via network connection 133. For example, a network interface can be a wireless interface such as, for example, a worldwide interoperability for microwave access (“WiMAX”) interface, a high-speed packet access (“HSPA”) interface, and/or a WLAN interface. A network interface can also be, for example, an Ethernet interface, a broadband interface, a fiber-optic interface, and/or a telephony interface.

A processor can be operatively coupled to a network interface such that the processor can be configured to be in communication with communication network 140 via a network interface. Furthermore, a processor can be any of a variety of processors. Such processors can be implemented, for example, as hardware modules such as embedded microprocessors, microprocessors as part of a computer system, Application-Specific Integrated Circuits (“ASICs”), and Programmable Logic Devices (“PLDs”). Some such processors can have multiple instruction executing units or cores. Such processors can also be implemented as one or more software modules in programming languages as Java™, C++, C, assembly, a hardware description language, or any other suitable programming language. A processor according to some embodiments includes media and computer code (also can be referred to as code) specially designed and constructed for the specific purpose or purposes.

The processor can further be operatively coupled to a memory. A memory can be, for example, a read-only memory (“ROM”); a random-access memory (“RAM”) such as, for example, a magnetic disk drive, and/or solid-state RAM such as static RAM (“SRAM”) or dynamic RAM (“DRAM”); and/or FLASH memory or a solid-data disk (“SSD”). In some embodiments, a memory can be a combination of memories. For example, a memory can include a DRAM cache coupled to a magnetic disk drive and an SSD.

In addition to a memory, some embodiments include another processor-readable medium (not shown) having instructions or computer code thereon for performing various processor-implemented operations. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floptical disks; solid-state memory such as SSDs and FLASH memory; and ROM and RAM devices. Examples of computer code include, but are not limited to, micro-code or micro-instructions, machine instructions (such as produced by a compiler), and files containing higher-level instructions that are executed by a computer using an interpreter. For example, an embodiment may be implemented using Java™, C++, or other object-oriented programming language and development tools. Additional examples of computer code include, but are not limited to, control signals, encrypted code, and compressed code.

In some embodiments, one or more of web server 120, content server 130, and/or computer terminal 150 be a virtual device implemented in software such as, for example, a virtual machine executing on or in a processor. For example, a content server can be a software module executing in a virtual machine environment such as, for example, a Java™ module executing in a Java™ Virtual Machine (“JVM”), or an operating system executing in a VMware™ virtual machine. In some such embodiments, a network interface, a processor, and a memory can be virtualized and implemented in software executing in, or as part of, a virtual machine.

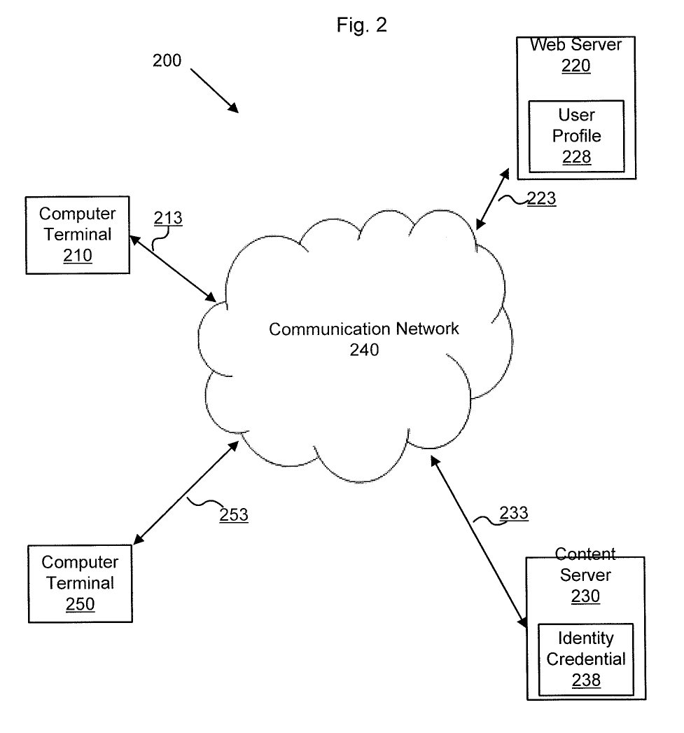

FIG. 2 is a system block diagram of system 200 for providing access to network content based on a context, according to another embodiment. System 200 includes computer terminal 210, web server 220, content server 230, and computer terminal 250 operatively coupled to communication network 240. Computer terminal 210 is operatively coupled to communication network 240 via network connection 213; web server 220 is operatively coupled to communication network 240 via network connection 223; content server 230 is operatively coupled to communication network 240 via network connection 233; and computer terminal 250 is operatively coupled to communication network 240 via network connection 253. Communication network 240 and network connections 213, 223, 233, and 253 can be similarly configured to the communication network and network connections described with respect to FIG. 1.

As illustrated in FIG. 2, web server 220 includes or provides access to user profile 228. For example, web server 220 can host or provide access to a social networking website or a dating website including user profiles. User profile 228 can be associated with, belong to, and/or represent a user of computer terminal 210. The user of computer terminal 210 can use a web browser to access, modify, and/or manage the user profile over communication network 240. In some embodiments, the user of computer terminal 210 can also view user profiles of other users of web server 220.

Additionally, as illustrated in FIG. 2, content server 230 can include an identity credential 238. Identity credential 238 can be, for example, a certificate, an image, a data file, and/or some other information such as validated identity information intended to verify the identity of an individual. For example, identity credential 238 can be associated with the identity of the user of computer terminal 210 (and user profile 228) and can be made available to users of other computer terminals to verify or validate the identity of the user of computer terminal 210.

In some embodiments, the user of computer terminal 210 can include a link or reference to identity credential 238 in user profile 228 on web server 220, for example, to verify or validate his or her identity to users of a social networking site. In some embodiments, the user of computer terminal 210 can place a link to a command set or software module such as a script file including instructions to cause a computer terminal to interact with content server 230 to retrieve identity credential 238. In some embodiments, the user of computer terminal 210 can update a user account accessible to content server 230 and associated with identity credential 238 to identify the URL of his or her user profile as a valid or authorized context or web address for identity credential 238. In other embodiments, the user of computer terminal 210 can update the user account with other information such as, for example, a screen name, alias, unique identifier that can be referenced by context server 230 to determine whether a request for identity credential 238 is associated with or originated from an authorized context.

A user of computer terminal 250 can access or view user profile 228 with, for example, a web browser running on computer terminal 250. The user of computer terminal 250 can select a link (e.g. the link established by the user of computer terminal 210) to the software module (e.g., by clicking with a mouse on a hyperlink such as an icon indicating the availability of an identity credential) to retrieve the software module. As described above, computer terminal 250 can communicate over network 240 with content server 230 to access identity credential 238.

In some embodiments, content server 230 receives the URL of user profile 228 from computer terminal 250 and uses a portion of the URL to access data in user profile 228 based on an API provided by web server 220 over communication network 240. For example, in some embodiments, content server 230 can use a portion of the URL having a unique identifier to access data or information associated with user profile 228 such as, for example, the screen name of the user associated with user profile 228 via the API and compare that screen name with one or more screen names approved as authorized contexts for identity credential 228 in the user account associated with identity credential. In some embodiments, content server 230 can request from the user of computer terminal 250 that user's screen name and/or password to web server 220 by, for example, sending commands to a web browser or web browser plug-in (e.g., located at computer terminal 250) in communication with content server 230 over communication network 240. This can be useful, for example, if web server 220 requires the screen name and/or password of a registered user of web server 220 for access to an API.

In some embodiments, other data can be requested from the user of computer terminal 250 and/or other portions of a URL can be used to determine whether a client module can be authenticated for access to data. In some embodiments the URL is compared with a list or database (or database table) in the user account associated with identity credential 238 to determine whether the URL is an authorized or approved context for access to identity credential 238. If the context of the request for identity credential 238 is authorized, identity credential 238 can be provided to computer terminal 250 from content server 230. Said differently, if computer terminal 250 (or a web browser, browser plug-in, or other client module running on computer terminal 250) has requested access to identity credential 238 from a context indicated as authorized for access to identity credential 238, computer terminal 250 is authorized to access content including identity credential 238 on content server 230. In other words, computer terminal 250 can be authenticated with or at content server 230 for access to identity credential 238.

In some embodiments, content server 230 can access an API provided by a third party (e.g., an API provided by a computer server other than web server 220) to determine whether a context is approved for access to data. For example, computer terminal 250 can provide to content server 230 a portion of a URL including an identifier of an item for sale on an online auction website and a request for an identity credential associated with the seller of the item. Content server 230 can retrieve from a database the seller's username for the online auction website and provide the seller's username to the online auction site via an API provided by the online auction website (e.g., by a computer server associated with the online auction website) to request a list of item identifiers of items the seller is selling. Content server 230 can then determine whether the identifier of the item provided by computer terminal 250 is included in the list of item identifiers received from the online auction website. If the identifier is included in the list, content server 230 can determine that the context is valid (or approved) for access to the identity credential and provide the identity credential of the seller to computer terminal 250. If the identifier is not included in the list, content server 230 can request additional context information from computer terminal 250, or can provide an indication to computer terminal 250 that the context is not approved.

In some embodiments, other information can be accessed by a content server via an API from a web server or other computer server. For example, digital certificates, encryption keys, screen names, unique identifiers, and/or other information can be accessed via an API. Additionally, in some embodiments, the information accessed via an API and/or associated with a context can be related to a person and/or a computer. Thus, in some embodiments, the context of a service request from a client such as a computer terminal (operated by a person) for data can be approved or authenticated, and the context of a service request from a computer or processor can be approved or authenticated. Furthermore, in some embodiments, data other than an identity credential can be provided by a content server.

In some embodiments, a content server can provide a service to a client such as a computer terminal. A service can be, for example, a data service configured to provide data such as image data, textual data, video data, validated or verified identity data such as identity credentials, or other data to a client. In some embodiments, a service can be a data processing service configured to process data such as image data, video data, textual data, or other data provided by a client. In some embodiments, a service can be a remote procedure call, a remote method invocation, or some other procedure executed at a content server (or other server) on behalf of a client module. In some embodiments, a content server can send a result of a procedure executed at the content server to the client module. In some embodiments, a client can send one or more service requests to a content server after being authenticated to the content server to access a service. In some embodiments, a client can send a service request to a content server and the service request can be authenticated or authorized by the content server. For example, a service request can be authorized by a content server if it is sent from an authenticated client. That is, a service request can be authorized by a content server if the client sending (or providing) the service request has been previously authenticated at the content server based on, for example, a command set and a context identifier. In some embodiments, a client can become unauthenticated from a content server. For example, authentication of a client can expire after a period of time or after a client sends a service request that requires a different authentication than the current authentication status of level of the client.

In some embodiments, a service request can be authorized separate from the authentication (or authenticated status) of a client based on, for example, the service request (e.g., a type of service, a class of service, or a specific service requested by the service request), a context identifier, and a command set received by the client. For example, a client can provide to the content server a service request for access to an identity credential, a context identifier, and a data set based on a portion of a command set. The data set can be, for example, a hash value or other value calculated from or based on the command set. The content server can authorize the service request based on the context identifier and the data set, and can send the identity credential to the client.

In some embodiments, the command set includes commands (or instructions) configured to cause the client to send a service request, provide a context identifier, and/or a data set to the context server. For example, the command set can be a script file including commands that a client can interpret and execute. In some embodiment, the command set can be an executable file including instructions (or commands) that a client can execute.

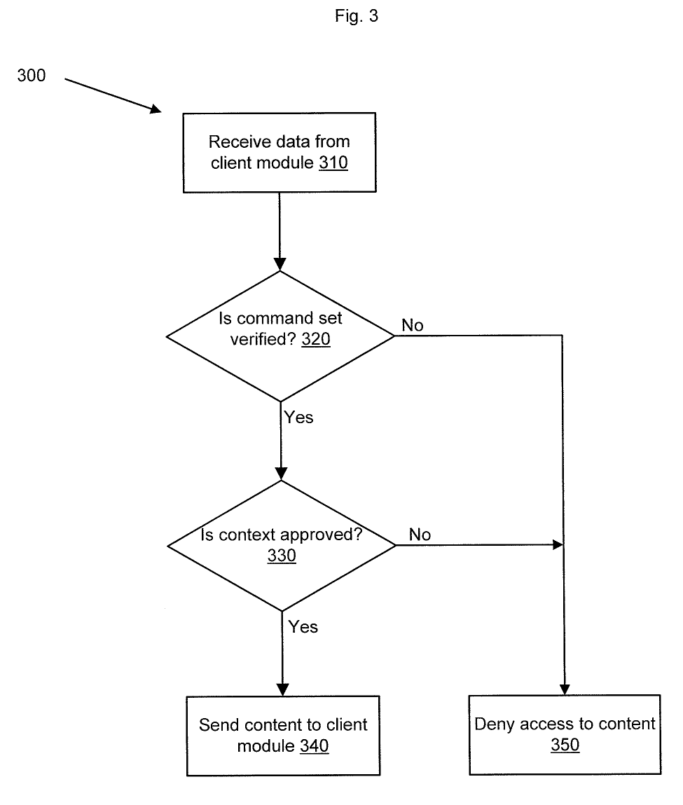

FIG. 3 is a flowchart of process 300 for providing access to network content based on a context, according to an embodiment. Process 300 can be, for example, a process or application executing on a processor or computer server. In some embodiments, process 300 can be implemented as a server module including one or more sub-modules for executing one or more steps of process 300. For example, steps 310 and 340 can be implemented by a first module, step 320 can be implemented by a second module in communication with the first module, and step 330 can be implemented by a third module in communication with the first module and/or the second module.

Data are received from a client module, at 310. Data can include, for example, a data set related to a software module or command set being executed or interpreted by the client module, such as a checksum or portion of the software module; a service request such as a request for data (e.g., text, image, account information, and/or identity verification) or for an action (e.g., perform some processing on data such as an image or account information) at a server; a context identifier related to the command set and/or service request such as a URL of a webpage and/or an identifier of a user account or profile; and/or other data. In some embodiments, the data include information associated with a person or computer terminal sending the data such as, for example, user or screen name for a website, a password, and/or an authentication or login token. In some embodiments, the data are received over a communication or computer network such as, for example, the Internet.

In some embodiments, a context identifier does not identify an entire or fully-qualified context, but characteristics or a portion of a context. For example, a URL can be a fully-qualified (or, fully-identified) context. That is, a URL can include all available information about an Internet context such as, for example, a domain name, a sub-domain name, a webpage name, and an identifier associated with a portion of a webpage. In some embodiments, a client module, a service request, or an access to data can be authenticated or authorized based on one or more context characteristics such as, for example, a domain name, a sub-domain name, a webpage anchor, a host name, or other context characteristics, rather than on a fully-qualified context. For example, based upon the context characteristics, the content server can approve the context (or authenticate a client module based on the context) without the context being fully, entirely, or exactly known or identified. In some embodiments, a content server can include a specific list of approved URLs (or fully-qualified contexts), and/or can include a list of webpages on a specific host or web server that are approved contexts for access to some data on the content server. The context can be approved based on a context characteristic identifying, for example, a webpage or specific host rather than on the fully-identified context.

After data are received, at 310, the command set being executed by the client module sending the data is verified, at 320. In some embodiments, the client module includes a copy of the command set in the data received, at 310. A server module can compare the command set with a command set accessible to the server module to determine whether the command set has been modified or altered. In some embodiments, changes to a command set such as values of parameters may be modified, but commands may not. In other words, if the value of a parameter is altered, the command set can be verified as approved or safe. If a command in the command set has been altered, the command set is not verified as approved and access to the content is denied, at 350. In some embodiments, the copy of the command set accessible to the server module is securely stored and/or encrypted.

In some embodiments, a client module can compute a hash value based on the command set and provide the hash value to a server module with the data received, at 310. The server module can compare the hash value with hash values in a list or database of hash value to determine whether the hash value is valid. For example, an identifier of the command set and a hash value can be included in the data received, at 310, and the server module can compare the received hash value with a hash value associated with the identifier of the command set in a database. If the two hash values are equal (or within some predefined tolerance) the command set can be verified as unaltered or approved.

At 330, authentication is determined. For example, in some embodiments, a server module can determine whether a command or action is approved or authenticated based on a context identifier included in the data set received, at 310. In other embodiments, a client module is authenticated based on a context identifier and the client module is permitted to execute requests, actions, and/or commands in the server module. Said differently, if a command set is verified and a context is approved at a server module, a client module can be authenticated with the server module such that the server module responds to commands, service requests, and other communication from the client module by performing some action.

In some embodiments, authentication is based on a context associated with a context identifier. For example, a server module can have access to a list or database of context identifiers that are approved. If the client module provides to the server module a context identifier approved for a particular request or command set, the service request and/or client module can be authorized for access to data on or accessible to the server module. In other words, if a client module provides to a server module a command set that is verified by the server module and a context that is approved for the command set, the client module can be authorized to interact with the server module based on the verified command set (e.g., the service request provided by the client module can then be executed by the server module). That is, the client module can be authenticated as a client module executing a valid, approved, and/or verified command set accessed from a valid, approved, and/or verified context. In some embodiments, communication between the client module and server module are secure. For example, the communication between the client module and server module can be encrypted.

If the context is approved and the service request and/or client module is authenticated, at 330, the server module can grant or execute the service request of the client module at 340. For example, the server can provide an image or some textual information to the client module. In some embodiments, the client module is authorized to provide additional service requests or commands to the server module based on the authentication. If the service request and/or client is not authenticated access to the content is denied, at 350.

In some embodiments, process 300 includes additional steps. For example, in some embodiments, process 300 includes additional steps for requesting and receiving additional information from a client module for authorization and/or verification. In some embodiments, if the command set is not verified at 320, server module requests additional information related to the command set from the client module. For example, if a client module provided a hash value of the command set to a server module and the hash value does not match any approved hash value, the server module can request that the client module re-compute hash value and provide the re-computed hash value. Alternatively, in some embodiments, the server module can request the command set if a hash value cannot be verified.

In some embodiments, a client module can provide a context characteristic to a server module. The server module can repeatedly request additional context characteristics from the client module and receive the additional context characteristics until the server module can authenticate the client module and/or authorize a service request, or until the server module determines that the context characteristics are insufficient for authentication and/or authorization. In other words, a server module can progressively request, for example, more information about a context and/or more detailed information about a context to determine that a service request is valid (or approved) within or from the context in or from which the client module is sending the service request. Thus, authentication and/or authorization can be progressive or adaptive.

Similarly, additional steps can include requesting additional information from a client module to authenticate a service request or client module. For example, a user name and/or password may be requested from a client module to access a database or API to a web site. Furthermore, a server module can provide to a client module an indication such as a status update to indicate that the client module is authenticated with the server module and/or is authorized to provide service requests to the server module.

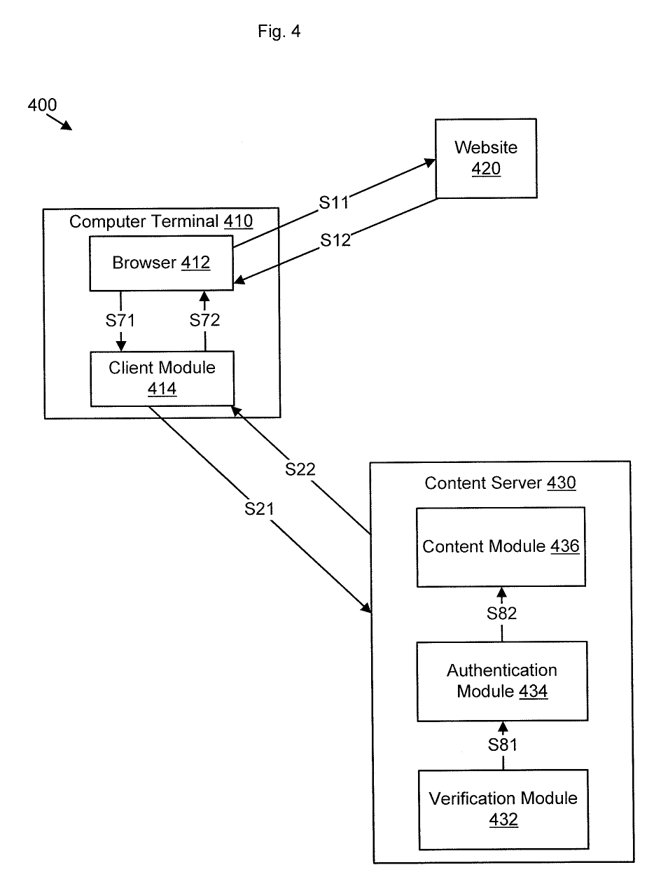

FIG. 4 is an illustration of communication in system 400 for authenticating a client module with a server module based on a context, according to an embodiment. System 400 includes computer terminal 410, website 420, and content server 430. Computer terminal 410 includes a browser 412 configured to communicate with or access website 420. Additionally, computer terminal 410 includes client module 414 configurable to communicate with content server 430. Content server 430 includes verification module 432, authentication module 434, and content module 436.

At S11, browser 412 requests (e.g., fetches) a command set from website 420. The request can be, for example, in response to a user action such as a mouse click on a link or icon at computer terminal 410. Website 420 provides the command set to browser 412, at S12. The command set and an identifier of website 420 (e.g., the URL of website 420) are provided to client module 414, at S71. Client module 414 receives the command set and identifier and begins interpreting the command set.

Client module 414 sends a service request for data to content server 430 based on the command set, at S21. In some embodiments, client module 414 computes a checksum or hash value based on the command set and sends the checksum or hash value and identifier of website 420 to content server 430, at S21. Verification module 432 receives the data sent, at S21, and verifies the command set. If the command set is verified, verification module 432 sends the identifier of website 420 and the service request to authentication module 434, at S81. Authentication module 434 determines, based on the website identifier, whether the context (e.g., context from which the command set was received) of the service request can be authenticated. If the context of the service request is authenticated, authentication module 434 sends the service request to content module 436, at S82. Content module 436 executes the service request and sends the result of the service request to client module 414, at S22.

In some embodiments, the result of the service request includes data or information that can be displayed in browser 412 and the result is provided to browser 412 from client module 414, at S72. For example, the result can include hypertext markup language (“HTML”) formatted data, an image, and/or Adobe Flash™ content.

In some embodiments, additional modules (not shown) can be included in content server 430. For example, content server 430 can include additional authentication modules. In some embodiments, content server 430 can include content or data accessible from multiple contexts or websites. Content server 430 can include one or more authentication modules to authenticate each context. In other words, one authentication module can authenticate service requests associated with one website, and another authentication module can authenticate service requests associated with another website. For example, the URLs from each website can include data of different formats that are properly interpreted by the respective authentication modules. Alternatively, one authentication module can be configured to communicate with a website via an API to provide authentication, and another authentication module can be configured to provide authentication based on data in a URL.

In some embodiments, website 420 can push a command set to computer terminal 410. For example, a software module can be pushed to browser 412 when website 420 is accessed by browser 412, and client module 414 can begin to interpret the software module without user input. Thus, data or content such as, for example, an identity credential can be accessed automatically when a user accesses website 420.

In some embodiments, a user of computer terminal 410 can subscribe to a service that provides pushed command sets to computer terminal 410 when the user accesses websites supporting the service. For example, a user of computer terminal 410 can login to the service using, for example, a single sign-on server (“SSoS”) that places a file or cookie in computer terminal 410. When the user accesses website 420, website 420 checks for the cookie and, if the cookie exists, pushes a command set to browser 412 to provide the user with, for example, validated data related to website 420 from content server 430. If the cookie does not exist, website 420 can provide the user with, for example, a link or icon to a software module accessible from content server 430 that can provide access to validated data, as discussed above.

In some embodiments, website 420 can be in communication with content server 430 and can provide a command set and/or a context identifier such as a URL to content server 430. For example, if the URL of website 420 is altered or changes (i.e., website 420 is moved), website 420 can notify content server 430 by, for example, sending a command set, the previous URL, and new URL. Content serve 430 can, for example, update a database of URLs associated with the command set based on the data sent by website 420.

In some embodiments, a command set or software module can include information or data relevant to authentication and authentication module 434. For example, a command set can include an identifier of a user account or permission set that includes a list or rules associated with approved or authorized contexts or context characteristics. In some embodiments, a command set can include an identifier of a specific authentication module from a group of authentication modules to be used for authenticating the service request and/or client module 414 based on the context or context characteristic(s) provided by computer terminal 410.

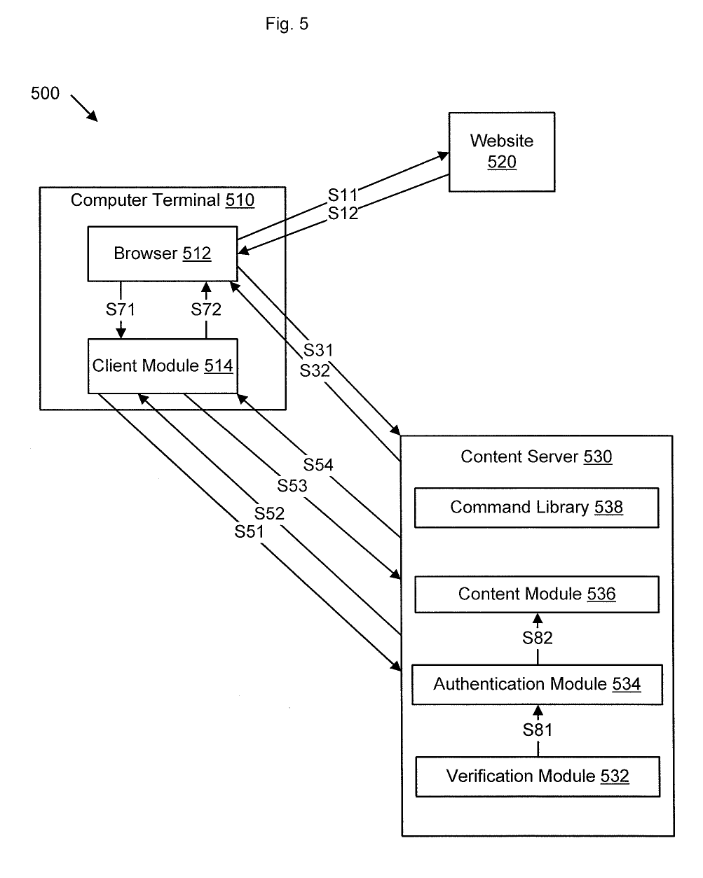

FIG. 5 is an illustration of communication in system 500 for authenticating a client module with a server module based on a context, according to another embodiment. System 500 includes computer terminal 510, website 520, and content server 530. Computer terminal 510 includes a browser 512 configured to communicate with or access website 520. Additionally, computer terminal 510 includes client module 514 configurable to communicate with content server 530. Content server 530 includes verification module 532, authentication module 534, content module 536, and command set library 538.

At S11, browser 512 requests a command set from website 520. The request can be, for example, in response to a user action such as a mouse click on a link or icon at computer terminal 510. Website 520 provides a reference or URL to a command set to browser 512, at S12. Browser 512 receives the URL and sends a request for the command set to content server 530, at S31. Content server 530 receives the request and accesses the command set from command set library 538. Command set 538 includes command sets associated with various contexts, data, and/or content accessible to content module 536. For example, command set library 538 can include a first command set configured to provide access to data validating the identity of an individual, and a second command set configured to provide access to a media file such as an audio, video, or audio/video file. Content server 530 can provide an appropriate command set from command set library 538 based on, for example, a parameter in the request from browser 512 such as a URL included in the request.

In some embodiments, command set library 538 can be configured to generate a command set based on a request for a command set. In some embodiments, content set library 538 (or some other module of content server 530) can generated a hash value based on the generated command set for use during verification of a command set provided by client module 514. In some embodiments, the hash value and/or command set are cached at a memory of content server 530 for use by verification module 532 and/or authentication module 534. In some embodiments, the hash value and/or command set are only temporarily cached such that the command set cannot be verified after a period of time because the cached hash value and/or command set have been deleted or removed from (or have been marked as invalid or expired within) the memory. Thus, in some embodiments, a command set and/or hash value can expire or become invalid. In some embodiments, a request for a command set can include the URL of a website including a link to content server 530, and command set library 538 can include the URL in the command set for use by verification module 532 and/or authentication module 534.

Content server 530 sends the command set to browser 512, at S32. The command set and an identifier of website 520 (e.g., the URL of website 520) are provided to client module 514, at S71. In some embodiments, website 520 is referred to as the context of the command set or a service request based on the command set. Client module 514 receives the command set and identifier and begins interpreting the command set.

Client module 514 sends a service request for data to content server 530 based on the command set, at S51. In some embodiments, client module 514 computes a checksum or hash value based on the command set, and sends the checksum or hash value and a context identifier of website 520 to content server 530, at S51. Verification module 532 receives the data sent, at S51, and attempts to verify the command set. If the command set is verified, verification module 532 sends the identifier of website 520 and the service request to authentication module 534, at S81.

Authentication module 534 determines, based on the website identifier, whether the context of the service request (e.g., context from which the command set was received) can be authenticated. If the context of the service request is authenticated, authentication module 534 sends the service request to content module 538, at S82. Content module 538 executes the service request and sends the result of the service request to client module 514, at S54. In some embodiments, the result of the service request includes data or information that can be displayed in browser 512 and the result is provided to browser 512 from client module 514, at S72.

If the service request is not authenticated, however, content server 530 can request additional data associated with the context, service request, and/or command set, at S52. In some embodiments, the request includes, for example, requesting one or more context characteristics and/or information from a user of computer terminal 510. For example, the request for additional data can be a request for a user name, a password, an account identifier, a domain name, a webpage identifier, and/or a URL. In some embodiments, client module 514 can interact with a user via browser 512. The client module 514 can then provide the requested data to content server 530, at S53. If authentication module 534 can authenticate the service request based on the additional data, content module 538 executes the service request and sends the result of the service request to client module 514, at S54.

Alternatively, if authentication module 534 cannot authenticate the service request based on the additional data, content server 530 can request yet additional data from client module 514, and client module 514 can provide the additional data. This process can repeat until the service request and/or client module is authenticated, or authentication module 534 determines the service request and/or client module cannot be authenticated. Authentication module 534 can determine that authentication is not possible based on, for example, a predefined maximum number of attempts, an incorrect user (or screen) name or password, a timeout period, and/or a lack of availability of a network service such as a website API. In some embodiments, a user of computer terminal 510 can be notified via browser 512 that authentication failed. In some embodiments, repeat or additional service requests from client module 514 are subject to the same or similar authentication as the original request described above.

In some embodiments, a client module and/or modules within a server module such as, for example, a content server can be distinct or discrete modules capable of communicating one with another. For example, in some embodiments, a client module can be the Adobe Flash Player™ and a verification module can be the Adobe Flash Media Server™. In such embodiments, a command set or software module can be a file compatible with the Adobe Flash Player™ such as, for example, a .swf file.

In one embodiment, a method includes receiving data, verifying a command set, determining whether a service request is authorized when the command set is verified, and performing an action if the service request is authorized. The data includes a data set associated with the command set, a context identifier, and a service request. The command set is verified based on the data set. The service request is authorized based on the context identifier. The action is associated with the service request. The data are received over a network.

In some embodiments, the context identifier is a uniform resource locator or a portion of a uniform resource locator of a webpage from which the command set can be retrieved. In some embodiments, the command set is a file including executable instructions configured to provide access to data on a computer server. In some embodiments, the command set is a script file including instructions configured to provide access to data on a computer server. In some embodiments, the data is a hash value or checksum value computed based on the command set.

In some embodiments, the action includes providing data requested in the service request to a client module. In some embodiments, the action includes providing an identity credential requested in the service request to a client module. In some embodiments, the method further includes requesting additional data associated with the context identifier.

In one embodiment, a method includes sending to a client module a command set, receiving data, verifying a command set, authenticating the client module when the command set is verified, and transmitting a response. The command set is sent over a network. The data are received over the network. The data includes a data set associated with the command set and a context identifier. The command set is verified based on the data set. The client module is authenticated based on the context identifier. The response is transmitted to the client module over the network and is based on a command from the command set.

In some embodiments, the client module is an Internet browser plug-in associated with a browser. In some embodiments, the context identifier is a uniform resource locator or a portion of a uniform resource locator of a webpage from which the command set can be retrieved. In some embodiments, the command set is a file including executable instructions configured to provide access to data on a computer server. In some embodiments, the command set is a script file including instructions configured to provide access to data on a computer server. In some embodiments, the data is a hash value or checksum value computed based on the command set. In some embodiments, the method further includes requesting additional data associated with the context identifier.

While certain embodiments have been shown and described above, various changes in form and details may be made. For example, some features of embodiments that have been described in relation to a particular embodiment or process can be useful in other embodiments. More specifically, for example, authentication methods discussed with respect to a webpage URL as a context can be applicable to context characteristics based on a portion of a URL or webpage, such as an HTML anchor tag, or a host name or identifier. Additionally, embodiments discussed with respect to web servers can be applicable to embodiments with other computer servers such as, for example, instant message (“IM”) servers, file servers, virtual private network (“VPN”) servers, mail servers, and/or other computers servers. Furthermore, embodiments discussed with respect to persons, individuals, and/or users can be applicable to embodiments in which the entities requesting information are computers, computer servers, and/or other machines, which do not involve direct human involvement.

Some embodiments that have been described in relation to a software implementation can be implemented as digital or analog hardware. Furthermore, it should be understood that the systems and methods described herein can include various combinations and/or sub-combinations of the components and/or features of the different embodiments described. Thus, features described with reference to one or more embodiments can be combined with other embodiments described herein.

What is claimed is:

1. A method, comprising:
sending a command set to a client module via a network;
receiving from the client module via the network a data set associated with the command set and a context identifier;
verifying the command set based on the data set; and
authenticating the client module based on the context identifier such that a service is accessible to the client module after the authenticating, the service being inaccessible to the client module before the authenticating.

2. The method of claim 1, wherein:
the service is a data service configured to provide a validated identity credential associated with the context identifier to the client module; and
the command set is a script file including commands configured to cause the client module to send the data set and the context identifier and commands configured to cause a client module to request the validated identity credential.

3. The method of claim 1, wherein:
the data set includes a hash value based on the command set; and
the context identifier includes a portion of a uniform resource locator associated with a network resource accessible to the client module.

4. The method of claim 1, wherein the context identifier includes a uniform resource locator associated with a first portion of a network resource and not associated with a second portion of the network resource.

5. The method of claim 1, further comprising sending, after the verifying and the authenticating, to the client module via the network an indication that the client module is authorized, based on the authenticating, to send service requests.

6. The method of claim 1, further comprising sending, after the verifying and the authenticating, to the client module via the network a response based on a command from the command set, the response including an identity credential associated with the context identifier.

7. The method of claim 1, further comprising:
receiving, after the authenticating, a service request from the client module, the service request being based on a command from the command set executed at the client module; and
performing an action associated with the service request.

8. The method of claim 1, wherein:
the data set associated with the command set is a first data set; and
the authenticating includes receiving from the client module a second data set associated with the command set, the second data set different from the first data set.

9. A method, comprising:
receiving from a client module a first context identifier and a service request via a network;
determining whether the service request is valid based on the first context identifier;
requesting, after the determining, a second context identifier from the client module; and
authorizing the service request based on the second context identifier.

10. The method of claim 9, further comprising providing access to data associated with the service request to the client module after the authorizing, the data being inaccessible to the client module before the authorizing.

11. The method of claim 9, wherein the client module is an Internet browser plug-in configured to access an Internet resource associated with the first context identifier and the second context identifier.

12. The method of claim 9, wherein the service request includes a request for access to an identity credential associated with at least one of the first context identifier or the second context identifier.

13. The method of claim 9, wherein the service request includes a request for access to an identity credential associated with at least one of the first context identifier or the second context identifier, the method further comprising sending the identity credential to the client module after the authorizing.

14. The method of claim 9, further comprising receiving from the client module a first hash value, the first hash value being based on a command set including the service request,
the determining including comparing the first hash value with a second hash value, the second hash value being a valid hash value for the command set.

15. The method of claim 9, wherein:
the first context identifier includes a portion of a uniform resource locator of a network resource accessible to the client module; and
the second context identifier includes a data set associated with a password related to the network resource accessible to the client module.

16. A method, comprising:
receiving via a network a data set associated with a command set, a context identifier, and a service request;
verifying the command set based on the data set;
determining whether the service request is authorized based on the context identifier; and
performing an action associated with the service request if the service request is authorized.

17. The method of claim 16, wherein:
the data set is received from a client module; and
the command set is a file including executable instructions accessible to the client module at a network resource associated with the context identifier.

18. The method of claim 16, wherein:
the data set is received from an Internet browser plug-in module; and
the command set is a script file accessible to the Internet browser plug-in module at a network resource associated with the context identifier.

19. The method of claim 16, wherein the performing includes sending an identity credential associated with the context identifier to an Internet browser plug-in module via the network.

20. The method of claim 16, wherein the data set is received from a client module, the method further comprising requesting from the client module, before the performing, data associated with the context identifier and different from the data set.

21. The method of claim 16, wherein the data set associated with the command set is a hash value based on the command set.
